(19) United States
(12) Patent Application Publication
(10) Pub. No.: US 2011/0314410 A1
(43) Pub. Date: Dec. 22, 2011

(54) COMPETITIVE EVENT STATISTIC DELIVERY DEVICE, SYSTEM, AND METHOD

(76) Inventor: Luis Viramontes, La Puente, CA (US)

(21) Appl. No.: 12/818,420

(22) Filed: Jun. 18, 2010

(51) Int. Cl. G06F 3/048; G09G 5/00

(52) U.S. Cl. 715/780; 715/830; 345/1.3; 348/E07.085

(57) ABSTRACT

A competitive event statistic delivery system, device, and method is disclosed. The system may include a primary display configured to display a competitive event. The system may also include a secondary display configured to display multiple streams of statistics as they relate to events displayed on the primary display. A selector may be configured to allow a user to dynamically and selectively pick from among the multiple streams of statistics for display on the secondary display.

### BACKGROUND

This application relates generally to information delivery devices. More specifically, this application relates to a device, system and method for delivering to viewers statistics related competitive events as they are viewing the event.

### SUMMARY

Currently while watching a sporting event, on television for example, spectators must rely on statistical information provided to them either by commentator(s) of the sporting event, or statistics provided on portions of the viewing screen by the broadcaster. However, many spectators are interested in seeing, or hearing, much more information, and/or information that is different from that provided by the commentator(s), or the broadcaster. In addition many spectators often enjoy analyzing a wide range of statistics about the players, and/or teams they are watching. Currently, event viewing displays, such as televisions, are not capable of providing the amount of statistics many event viewers would like. The displays/broadcasts also lack flexibility.

Also when players play a video game, the information typically provided to them is limited to the current action, and/or the score of the game.

Therefore, there is a significant need for a competitive event statistic delivery device, system, and method that may be configured separate from a first, or primary event viewing display, but operatively linked to the primary display while the event is being displayed, and which can provide more statistics in a flexible way. The competitive event may be for example a sporting event, or a video game.

There is also a significant need to be able to provide statistics on various video game conditions, such as, but not limited to information about the players, the player's past gaming achievements, the history of the game, similar games etc.

This application discloses competitive event statistic delivery device, system, and method that is economical to produce, of simple implementation, and capable of mass production, but also capable of providing a user a unique and customized viewing experience.

In particular, this application discloses a competitive event statistic delivery system. The system may include a primary display configured to display a competitive event. The system may also include a secondary display configured to display multiple streams of statistics as they relate to events displayed on the primary display. A selector may be configured to allow a user to dynamically and selectively pick from among the multiple streams of statistics for display on the secondary display.

This application also discloses a competitive event statistics delivery device to be used in conjunction with a primary display. The primary display may be configured to display a competitive event such as a sporting event, or a video game. The device may include an occurrence linking module configured to link to occurrences during the competitive event as they are displayed on the primary display. A secondary display may be configured to provide a user with visual or audible statistics about the competitive event while they may be watching the event on the primary display wherein the statistics may be tied to the events as they occur.

Various operations may be described as multiple discrete operations in turn, in a manner that may be helpful in understanding embodiments of the present invention; however, the order of description should not be necessarily be construed to imply that these operations are order dependent.

Finally, this application discloses a method of providing competitive event statistics to a spectator of a competitive event. The method may include establishing a communication link to a statistics delivery device controllable by a user. The statistics delivery device may have an interface. The method may also include linking competitive occurrences as they are shown to occur during a competitive event to multiple possible streams of statistics, the multiple possible streams of statistics being retrievable from a data store. The method may include providing to the user, via the interface, a user specified stream of statistics from the data store from among the multiple possible streams of statistics.

### BRIEF DESCRIPTION OF THE DRAWINGS

The drawing, when considered in connection with the following description, is presented for the purpose of facilitating an understanding of the subject matter sought to be protected.

FIG. 1 is a schematic view illustrating an example system 10 and an example device 50 in accordance with the current disclosure.

### DETAILED DESCRIPTION

While the present sports statistic delivery device, system, and method is described with reference to several illustrative embodiments described herein, it should be clear that the present invention should not be limited to such embodiments. Therefore, the description of the embodiments provided herein is illustrative of the present invention and should not limit the scope of the invention as claimed. In addition, while the following description references a drawing showing particular configurations and proportions, it will be appreciated that the invention may be configured to have other configurations and proportions.

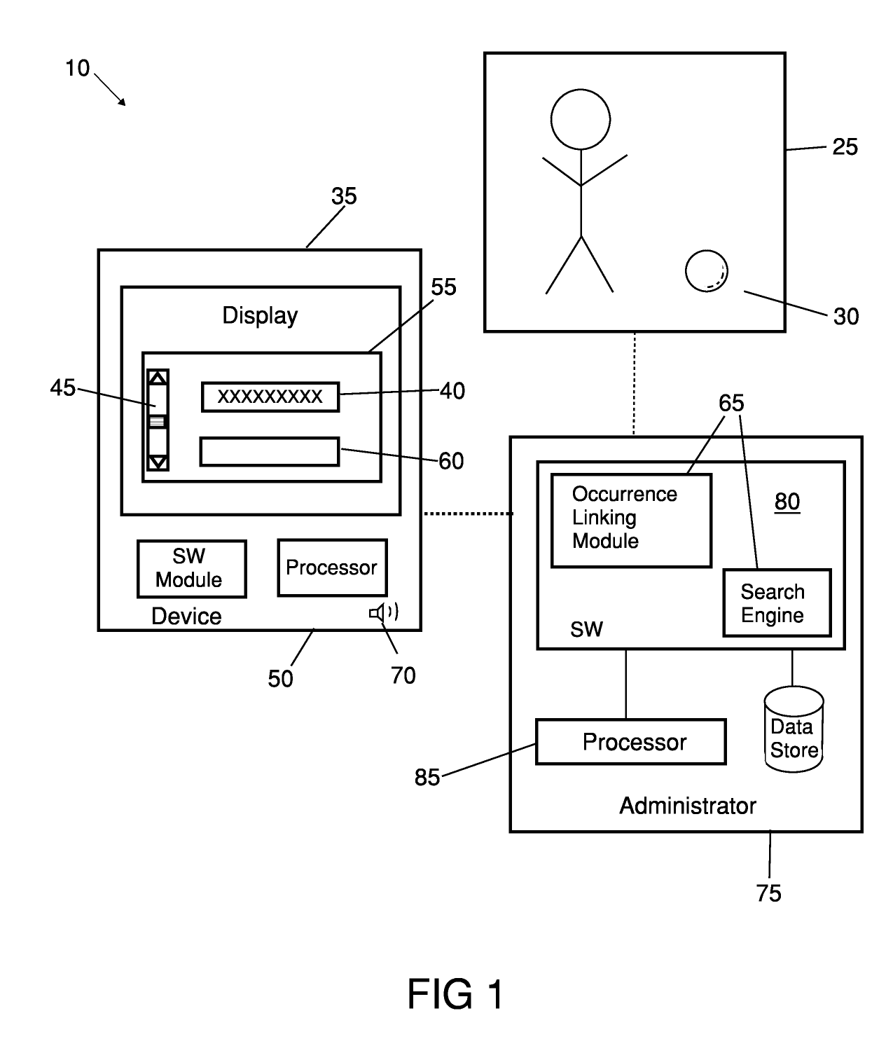

FIG. 1 is a schematic view illustrating a first example embodiment according to the current disclosure. A competitive event statistic delivery system 10 is illustrated. The system 10 may include a primary display 25 that may be configured to display a competitive event 30 such as a sporting event, or players competing in a video game, or the like. The system 10 may also include a secondary display 35 configured to display multiple streams of statistics 40 as they relate to events displayed on the primary display 25. A selector 45 may be configured to allow a user to dynamically and selectively pick from among the multiple streams of statistics 40 for display on the secondary display 35. In the example illustrated a scroll bar is shown as an example selector 45. It will be understood that many other selector configurations are possible without departing from the scope of the disclosure. Streams of statistics 40 may refer to groups of related information, or discrete items, or various combinations thereof.

The secondary display 35 may be included in a device 50 which may be a remote and/or portable handheld device. The system 10 may include an interface 55. In the example illustrated the interface 55 is shown included as part of the secondary display 35. In some examples the interface 55 may be separate from the secondary display 35.

The interface 55 may include a query field 60 configured to allow a user to input a query about the competitive event 30. The system 10 may further include a search engine 65 configured to retrieve a closest fit answer to the query. The closest fit answer may be provided to the user via the secondary display 35, as for example, a statistic 40.

In some examples the primary display 25 may be a television. In some examples the secondary display 35 may be one or both of an LCD (liquid crystal display) display screen, and an HD (high definition) display screen.

FIG. 1 also illustrates another example embodiment. FIG. 1 illustrates a competitive event statistics delivery device 50 to be used in conjunction with the primary display 25. The primary display 25 may be configured to display a competitive event 30 such as a sporting event, or a video game. The device 50 may include an occurrence linking module 65 configured to link to occurrences during the competitive event 30 as they are displayed on the primary display 25. In most cases it may be as the occurrences actually occur. The secondary display 35 may be configured to provide a user with visual or audible, as illustrated with microphone 70, statistics about the competitive event while they are watching the event on the primary display 25 wherein the statistics 40 may be tied to the events as are displayed.

The device 50 may be constructed from any sufficiently durable and resilient material, and may include various readily available components such as power delivery and control systems, display systems, logic systems, memory systems and the like.

All or parts of the occurrence linking module 65 may be functionally and physically included in either or both of the primary display 25, or the secondary display 35, or configured as a separate component. The occurrence linking module 65 may be included in an administrator 75. The linking module 65 and/or the administrator 75 may be included in, or implemented by software 80 that may be enabled by a processor 85. The administrator 75 may be a cloud computing device, and in most cases, the administrator 75 may be included in a local network.

The interface 55 of the competitive event statistics delivery device 50 may be configured to enable selective changes to predetermined categories of statistics 40 displayed on the interface 55, and/or to enable the user to change a first visible statistic to another statistic, making the other statistic visible.

The device 50 may include a statistics type adjustment feature 45 as illustrated with the example scroll bar discussed above. The statistics type adjustment feature 45 may be configured to allow the user to selectively adjust a category of statistics by scrolling a list of statistics 40, or statistics categories. The statistics type adjustment feature 45 may be configured to provide the user with a preselected list of categories of statistics 40.

In some examples the statistics type adjustment feature 45 may be configured to allow the user to selectively adjust a category of statistics 40 by navigating a hierarchical category structure. For example one level of hierarchy in an example hierarchical structure may include categories such as, without limitation, BATTING STATISTICS, BASERUNNING STATISTICS, PITCHING STATISTICS, FIELDING STATISTICS, and GENERAL STATISTICS. Then one or more of the first level of statistic may be expanded further. For example, the BASERUNNER category may include statistics on, without limitation, how often, or the percentage of times the player has been CAUGHT STEALING, while attempting to steal a base; or, the number of RUNS SCORED; or, the number of STOLEN BASES, or the like.

In some cases the statistics which may be available to be displayed may be generally related to the event, and/or may be specific to particular occurrences, as they happen, or as they are displayed to happen during the competitive event.

The statistics specific to particular occurrences during the competitive event may include statistics regarding one or more of the group including, without limitation: statistics regarding the player with the ball, or the player currently at bat, statistics regarding the other players currently on the field, statistics regarding a change in the weather, and statistics regarding a change in score in the game, and the like.

The statistics generally related to the event may include statistics from one or more of the group including without limitation: statistics regarding the competitors, statistics regarding the venue, statistics regarding past competitive events played under similar weather conditions, statistics regarding past competitive events played on similar field conditions, statistics regarding past competitive events played on the same day of the week, and statistics regarding past competitive events played on the same day of the month, and the like.

The occurrences are one or more selected from the group including without limitation: an appearance of a particular player in the event; a team, or player scoring; a turn of participation of a particular player in the event; events particular to temporal conditions of a current playing venue such as whether the game takes place at night, or in the day, or weather conditions, and the like; events particular to a current playing venue; events particular to other past playing venues; and the like.

As an example, of statistics that may be provided according to the current disclosure: A player may be up at bat. The player's statistics may be displayed. These statistics may include his batting average—what his batting average is against the particular pitcher; what his batting average is on day games—on Thursdays; what his batting average is when playing on grass; what his batting average is at the current ball/strike count, and so on. The statistics may relate to this particular game and/or the player/teams season. These statistics may be updated in real time. The statistics may relate to a single player, a plurality of players, team, or teams. This may be controlled all at the whim of the user.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A competitive event statistic delivery system comprising:
a primary display configured to display a competitive event;
a secondary display configured to display multiple streams of statistics as they relate to events displayed on the primary display; and
a selector configured to allow a user to dynamically and selectively pick from among the multiple streams of statistics for display on the secondary display.

2. System of claim 1, wherein the competitive event is a sporting event.

3. System of claim 1, wherein the competitive event is a video game.

4. System of claim 1, wherein the primary display is a television.

5. System of claim 1, wherein the secondary display is one or both of an LCD (liquid crystal display) display screen, and an HD (high definition) display screen.

6. System of claim 1, wherein the secondary display includes an interface, the interface including a query field configured to allow a user to input a query about the competitive event, and further comprising a search engine configured to retrieve a closest fit answer to the query, and wherein the closest fit answer is provided to the user via the secondary display.

7. System of claim 1, wherein some of the multiple streams of statistics available to be displayed are generally related to the event, and some of the multiple streams of statistics available to be displayed relate to particular occurrences as they happen during the competitive event.

8. A competitive event statistics delivery device to be used in conjunction with a primary display, the primary display configured to display a competitive event such as a sporting event, or a video game, the device comprising:
an occurrence linking module configured to link to occurrences during the competitive event as they are displayed on the primary display; and
a secondary display configured to provide a user with visual or audible statistics about the competitive event while they are watching the event on the primary display wherein the statistics are tied to the events as they are displayed.

9. The competitive event statistics delivery device of claim 8, further comprising an interface configured to enable selective changes to predetermined categories of statistics displayed on the interface and/or to enable the user to change a first visible statistic to another statistic.

10. The competitive event statistics delivery device of claim 8, further comprising a statistics type adjustment feature configured to allow the user to selectively adjust a category of statistics by scrolling a list of statistics categories.

11. The competitive event statistics delivery device of claim 8, further comprising a statistics type adjustment feature configured to allow the user to selectively adjust a category of statistics by navigating a hierarchical category structure.

12. The competitive event statistics delivery device of claim 8, wherein the statistics type adjustment feature is a query field configured to allow a user to input a query about the competitive event, and further comprising a search engine configured to retrieve a closest fit answer to the query, and wherein the closest fit answer is provided to the user via the display.

13. The competitive event statistics delivery device of claim 8, wherein statistics are available to be displayed that are generally related to the event, and/or that are specific to particular occurrences during the competitive event.

14. The competitive event statistics delivery device of claim 13, wherein the statistics specific to particular occurrences during the competitive event include statistics regarding one or more of the group consisting of:
statistics regarding the player with the ball, or the player currently at bat,
statistics regarding the other players currently on the field,
statistics regarding a change in the weather, and
statistics regarding a change in score in the game.

15. The competitive event statistics delivery device of claim 13, wherein statistics generally related to the event includes statistics from one or more of the group consisting of:
statistics regarding the competitors,
statistics regarding the venue,
statistics regarding past competitive events played under similar weather conditions,
statistics regarding past competitive events played on similar field conditions,
statistics regarding past competitive events played on the same day of the week, and
statistics regarding past competitive events played on the same day of the month.

16. The competitive event statistics delivery device of claim 8, wherein the occurrences are one or more selected from the group consisting of:
an appearance of a particular player in the event,
a team, or player scoring,
a turn of participation of a particular player in the event,
events particular to temporal conditions of a current playing venue,
events particular to a current playing venue, and
events particular to other past playing venues.

17. The competitive event statistics delivery device of claim 8, wherein the interface is one or both of an LCD (liquid crystal display) display screen, and an HD (high definition) display screen

18. A method of providing competitive event statistics to a spectator of a competitive event using a statistics delivery system, the method comprising:
establishing a communication link to the statistics delivery device controllable by a user, the statistics delivery device having an interface;
linking competitive occurrences as they are shown to occur during a competitive event to multiple possible streams of statistics, the multiple possible streams of statistics being retrievable from a data store; and
providing to the user, via the interface, a user specified stream of statistics from the data store from among the multiple possible streams of statistics.

19. The method of claim 18, wherein user specified stream of statistics is selectable by scrolling a list of statistic categories.

20. The method of claim 18, wherein user specified stream of statistics is selectable by navigating a hierarchical category structure.
